(19) United States
(12) Patent Application Publication
(10) Pub. No.: US 2026/0312623 A1
(43) Pub. Date: Oct. 8, 2026

(54) METHOD FOR PROVIDING NFC DATA EXCHANGE FORMAT MESSAGES

(71) Applicant: Silicon Craft Technology PLC, Bangkok (TH)

(72) Inventors: Prem TOSASUKA, Nontaburi (TH); Kaweerat RAJATAVAN, Nontaburi (TH)

(73) Assignee: Silicon Craft Technology PLC, Bangkok (TH)

(21) Appl. No.: 19/097,906

(22) Filed: Apr. 2, 2025

(51) Int. Cl. H04B 5/77; H04B 5/22; H04W 80/10

(52) U.S. Cl. CPC H04B 5/77; H04B 5/22; H04W 80/10

(57) ABSTRACT

A method for providing NFC data exchange format (NDEF) messages for a communication between an NFC enabled device and an NFC device is described. The method comprises calculating the length of an NDEF message, converting data stored in a first data format to a second data format, and remapping addresses requested by the NFC enabled device to block addresses of a user data memory unit. The length of the NDEF message is calculated by calculating the length of a URI using an address of a V-field and an address of the data, determining the size of the data in form of the second data format, and adding the length of the URI with the size of the data in form of the second format to obtain the length of the NDEF message.

### FIELD AND BACKGROUND OF THE INVENTION

The present invention relates to the field of Near Field Communication (NFC), and more particularly, to method for providing NFC data exchange format messages.

Near Field Communication (NFC) is a short-range wireless communication technology that enables data transfer and exchange between an NFC enabled device and an NFC device when they are in close proximity to each other, typically within a few to several centimeters. An NFC enabled device is an electronic device incorporated with an NFC integrated circuit (IC), such as an NFC mobile phone, an NFC reader terminal. An NFC device may be an NFC tag. Data transfer and exchange between an NFC enabled device and an NFC device employs a form of NFC Data Exchange Format (NDEF).

NDEF is a standardized data format for NFC wireless communication that allows an NFC enabled device and an NFC device to exchange information seamlessly. It defines a standard structure for storing and exchanging data between an NFC enabled device and an NFC device, ensuring interoperability and compatibility. The NDEF messages can contain various types of data, including texts, URI (Uniform Resource Identifier), and more. The NDEF messages consist of records, and each record holds a specific type of data along with additional metadata. These records can be stacked together within an NDEF message, providing a flexible and extensible format for NFC data exchange. The NDEF standard is crucial for widespread adoption and usage of NFC technology, as it ensures that an NFC enabled device and an NFC device from different manufacturers can understand and interpret the data being exchanged, promoting a seamless and standardized user experience.

An NFC tag comprises an antenna and an NFC IC, which further comprises a communication unit, a processing unit and a memory unit. The NFC tag is a passive tag or an active tag. A passive NFC tag, which does not include a power source, collects energy for its operation from a nearby NFC interrogator or reader. An active NFC tag includes an energy source such as a battery. In many applications, an NFC tag includes a peripheral unit, which is used to provide measurement of physical parameters such as temperature or pressure. The NFC tag can be used for various functions, particularly data collection. In many applications, the NFC tag is used for recording and storing time-stamped data, such as environmental measurements, logistics information, or other parameters. As data stored in the memory unit of the NFC tag expands, the time required to read or retrieve the data is increased and may become unacceptably long for many applications which rely on real-time data monitoring and analysis, potentially leading to delayed responses to critical events or trends. The primary issue addressed by the present invention is the extended data retrieval time in the NFC tag without requirement of a data logging application software to read NDEF messages sent from the NFC tag.

In a communication between an NFC reader and an NFC tag, once the NFC reader detects the NFC tag, the NFC reader sends a command to select and acknowledge the NFC tag. Subsequently, the NFC reader issues a command to request data by sending a read command to retrieve data from the first address in the NFC tag’s memory unit. Typically, this first address contains information that characterizes the memory unit structure of the NFC tag. After determining the memory unit characteristics, the NFC reader proceeds to send commands to retrieve the data stored in the NFC tag’s memory unit. It does so sequentially, issuing read commands for each memory unit address up to the last address. The last address is identified based on the length of the NDEF message, which is determined by the maximum capacity of the NFC tag’s memory unit. Data stored in all memory unit addresses of the NFC tag may include necessary data and/or unnecessary data. As a result, the NFC reader receives both necessary data and unnecessary data from all memory unit addresses. This unnecessary data comprises predefined values set by the NFC tag manufacturer, and/or previous data that were stored in the memory unit, which can increase the communication time between the NFC tag and the NFC reader.

A prior art addresses the issue of unacceptably long data retrieval time by including application software with the NFC device. Each NFC device platform has its own specific application software designed exclusively for that device. When users switch to a different NFC device, the users must download the corresponding application software to continue using the device. This software is configured to control the NFC device, allowing it to issue a set of commands to obtain essential information about the NFC tag, such as the memory unit size and the number of data entries. Once the essential information is obtained, the application software calculates the required data size and issues read commands only for the necessary data, thereby avoiding the retrieval of unnecessary data and reducing processing time. Thus, the data retrieval time is shortened, but it requires the users to install the specified application software for the NFC device. This increases the complexity for the users to be able to use their NFC devices.

Therefore, there is a need for a method for providing data from an NFC tag or NFC device that reduces data retrieval time between an NFC reader or NFC enabled device and the NFC tag or NFC device while optimizing memory unit storage utilization. Additionally, there is a need for a method for retrieving data from an NFC device or NFC tag without requiring specific application software.

### SUMMARY OF THE INVENTION

The present invention described herein generally relates to a method for providing NFC data exchange format messages. The method comprises the steps of storing data in form of a first data format in a memory unit of an NFC device or NFC tag, calculating the length of an NDEF message by an NFC device or NFC tag, converting the data from the first data format to a second data format, and remapping an address from the memory unit of the NFC device to a requested address by an NFC enabled device for transmission an NDEF message to an NFC enabled device. The length of the NDEF message is calculated by calculating the length of a URI by using an address of a V-field and an address of the data in the user data memory unit, determining the size of the data in form of the second data format, adding the length of the URI with the size of the data in form of the second format to obtain the length of the NDEF message, storing the length of the NDEF message in a memory unit of the NFC device, and remapping requested addresses by the NFC enabled device with block addresses from the memory unit of the NFC tag.

The general purpose of the present invention is to reduce the data retrieval time between the NFC enabled device and the NFC device without the need to install a specific application software and the method described herein is compatible with any NFC enabled device.

### BRIEF DESCRIPTION OF THE SEVERAL VIEWS OF THE DRAWINGS

FIG. 1 shows a sequence diagram of communication between an NFC tag and an NFC enabled device with an application software, according to prior arts.

FIG. 2 shows a simplified block diagram of an NFC communication system between an NFC enabled device and an NFC device, according to an exemplary embodiment of the present invention.

FIG. 3 shows a memory unit configuration of the NFC device, according to an exemplary embodiment of the present invention.

FIG. 4A shows a storage memory of an NFC device used with an NFC enabled device, according to prior arts.

FIG. 4B shows a storage memory of an NFC device used with an NFC enabled device and an application software, according to prior arts.

FIGS. 5A and 5B demonstrate a user data memory unit, according to an exemplary embodiment of the present invention.

FIG. 6A illustrates a user data memory unit when the NFC enabled device sends a reading command to the NFC device in the NFC device perspective, according to an exemplary embodiment of the present invention.

FIG. 6B illustrates a user data memory unit when the NFC enabled device sends a reading command to the NFC device in the NFC enabled device perspective, according to an exemplary embodiment of the present invention.

FIG. 7 illustrates a sequence diagram of a method for providing NDEF messages, according to an exemplary embodiment of the present invention.

### DESCRIPTION OF SPECIFIC EMBODIMENTS OF THE INVENTION

In a communication between an NFC enabled device or NFC reader and an NFC device or NFC tag, the users are generally required to install a specific application software to the NFC enabled device. The application software is used to instruct the NFC enabled device to send commands to the NFC device to request information from the NFC device, which include Uniform Resource Locators (URIs), texts, web addresses, logged data. The requested information is typically stored in a storage memory of the NFC device, which is designed to hold a large amount of data. The NFC device with a large volume of storage memory requires longer communication time with the NFC enabled device.

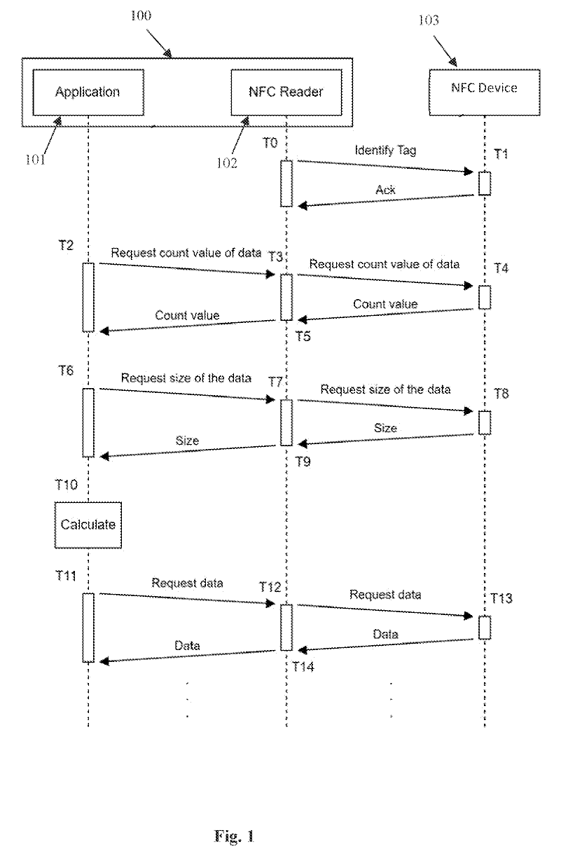

FIG. 1 shows a sequence diagram of communication between the NFC device and the NFC enabled device, according to a prior art. The NFC enabled device 100 comprises an application software 101 and an NFC reader 102. The NFC reader 102 is an electronic device or hardware configured for NFC communication. The communication between the NFC device 103 and the NFC enabled device 100 typically begins at T0 when the NFC enabled device 100 sends a first command to identify and select the NFC device 103. At T1, the NFC device 103 receives the first command and sends a first response to acknowledge the NFC enabled device 100. Next, the application software 101 is operated by a user. At T2, the application software 101 sends a second command via the NFC reader 102 to the NFC device 103 to request for a count value of the data 408, which indicates the total amount of the data 408 stored in the storage memory 400 of the NFC device 103. The NFC device 103 sends a second response including the count value of the data 408 to the NFC enabled device 100 at T4. The NFC reader 102 receives the second response from the NFC device 103 and forwards it to the application software 101. Next, at T6, the application software 101 sends a third command via the NFC reader 102 to the NFC device 103 to request for the size of the data 408. At T8, the NFC device 103 receives the third command and sends a third response including the size of the data 408 back to the NFC enabled device 100. The NFC reader 102 receives the third response from the NFC device 103 and forwards it to the application software 101. At T10, the application software 101 has received both the count value, and the size of the data 408 stored in the NFC device 103. The application software 101 uses the received count value and the size of the data 408 to calculate the total amount of the data 408 stored in the NFC device 103. Next, at T11, the application software 101 sends a fourth command via the NFC reader 102 to the NFC device 103 to request for the data 408 stored in the storage memory 400 of the NFC device 103. The NFC device 103 sends a fourth response including the data 408 back to the NFC enabled device 100 at T13. The NFC reader 102 receives the fourth response from the NFC device 103 and forwards it to the application software 101. This will be repeated until the NFC enabled device 100 receives the total amount of the data 408 stored in the NFC device 103.

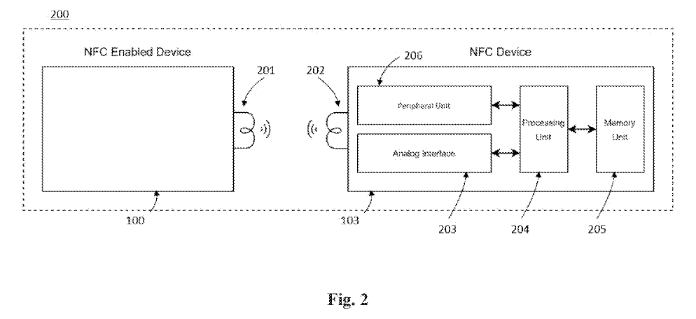

FIG. 2 shows a simplified block diagram of an NFC communication system between the NFC enabled device and the NFC device, according to an exemplary embodiment of the present invention. The NFC communication system 200 comprises the NFC enabled device 100 and the NFC device 103. The NFC enabled device 100 comprises the NFC reader 102 and a reader’s antenna 201. The NFC reader 102 attached to the reader’s antenna 201. The NFC reader 102 is configured to request and receive an NDEF message 402 in response to the request from the NFC device 103. The NFC device 103 comprises an NFC device’s antenna 202, an analog interface 203, a processing unit 204, a memory unit 205, and a peripheral unit 206. The NFC device’s antenna 202 is attached to the NFC device 103 and is configured to receive an electromagnetic wave transmitted by the NFC enabled device 100 and converts the electromagnetic wave to an electrical signal at the NFC device’s antenna 202. The analog interface 203, which includes electronic circuits and components, is connected to the processing unit 204 and coupled to the NFC’s device antenna 202 and is configured to provide a communication interface between the electrical signal at the NFC device’s antenna 202 and the processing unit 204. The processing unit 204 is connected to the peripheral unit 206, the analog interface 203 and the memory unit 205. The processing unit 204 is configured to manage the NFC communication by interpreting signals from the analog interface 203, handling data access to the memory unit 205, executing commands, obtaining data from the peripheral unit 206, and storing lengths of NDEF messages 402 in the memory unit 205. The memory unit 205 is configured to store data used in the NFC communication and system operation. The memory unit 205 hold various types of information that the NFC device 103 transmits to or receives from the NFC enabled device 100. The information stored in the memory unit 205 encompass website URIs, authentication codes, product details, or any programmed content shared during the NFC communication. The peripheral unit 206 is configured to capture and provide data to the processing unit 204 in form of a first data format. The peripheral unit 206 includes sensors and electronic circuits that measure various types of data such as temperature, pressure, or humidity, as well as a serial data interface that collects the data. The peripheral unit 206 enhances the capability of the NFC device 103 for data logging, which allows the NFC communication to provide insights into conditions or parameters being monitored and enabling better analytics and decision-making processes.

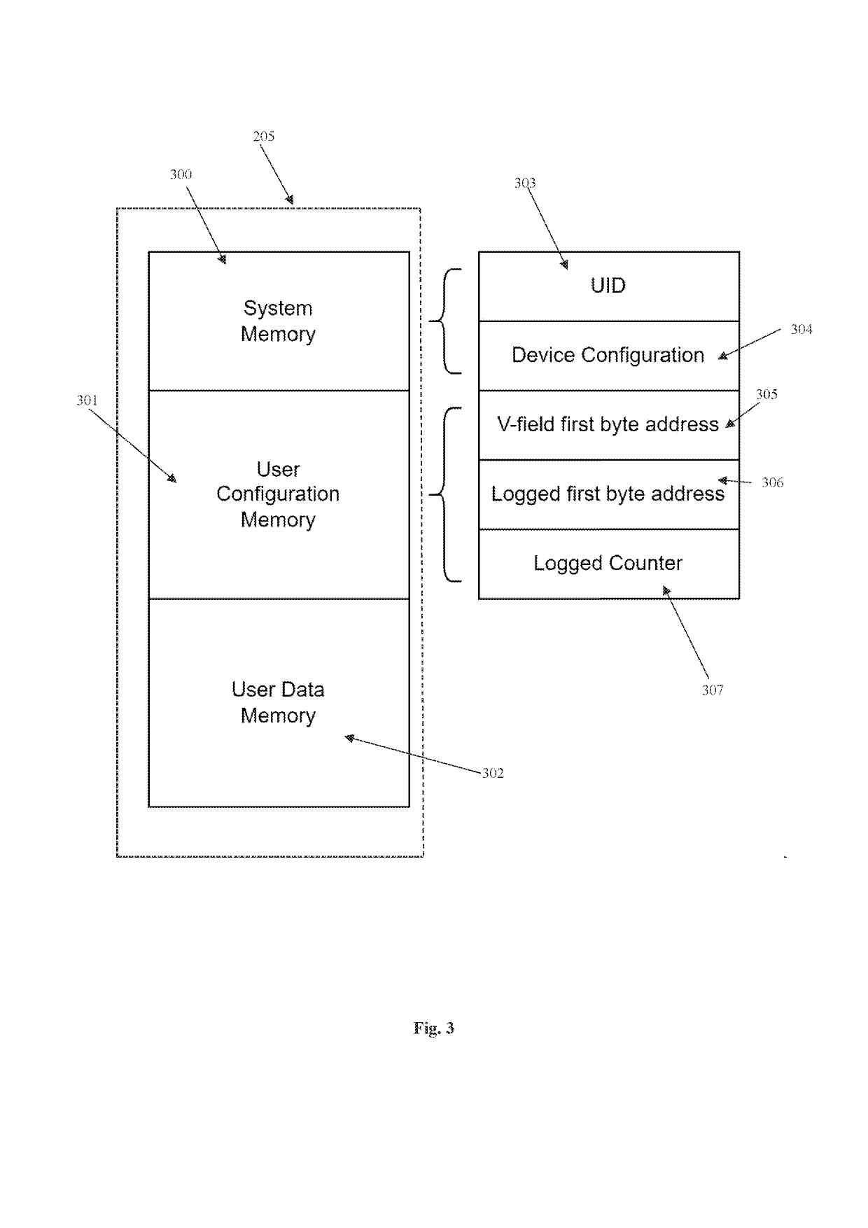

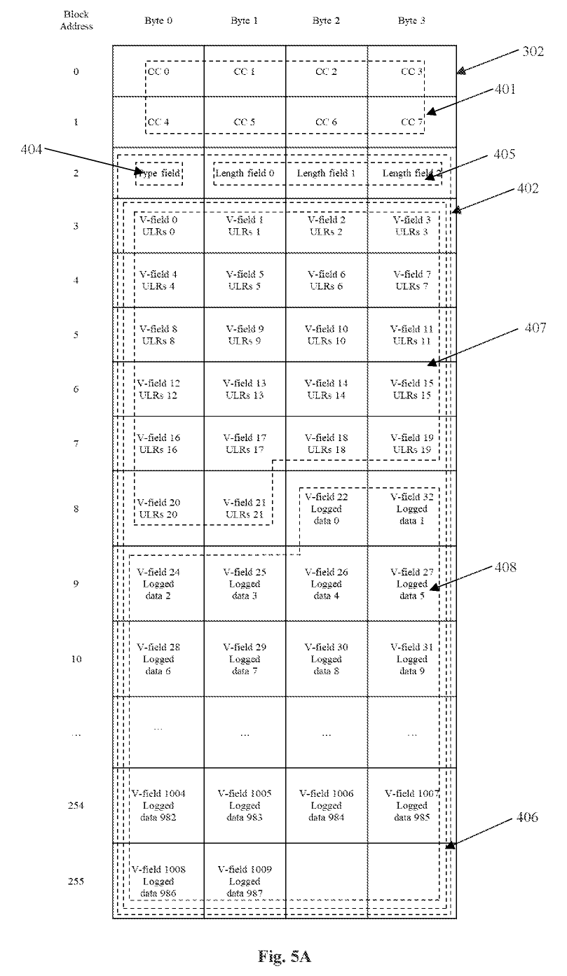

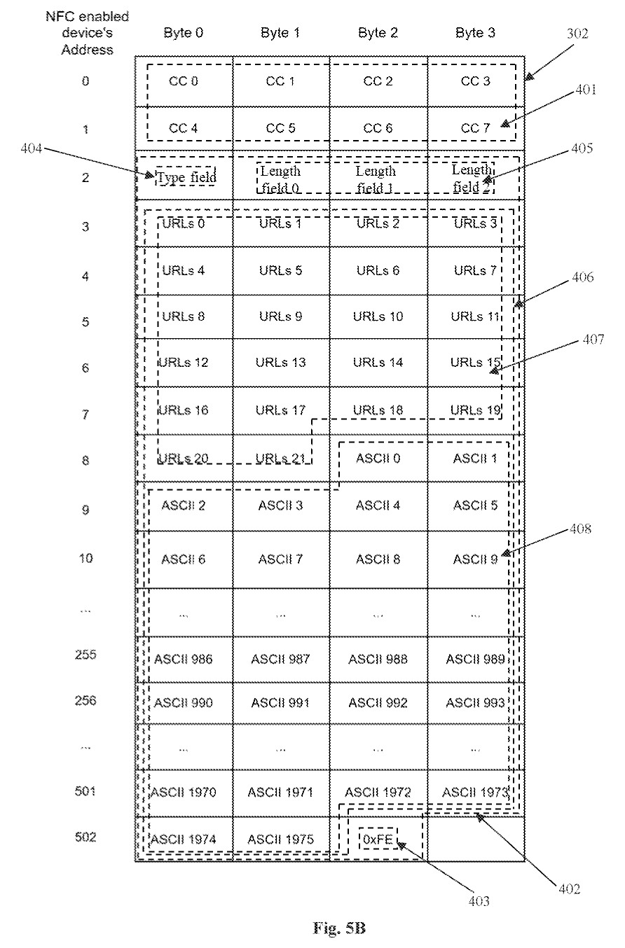

FIG. 3 illustrates a configuration of the memory unit of the NFC device, according to an exemplary embodiment of the present invention. The memory unit 205 comprises a system memory unit 300, a user configuration memory unit 301 and a user data memory unit 302. The system memory unit 300, which is generally not accessible to a user, is configured to store indicative data of the NFC device 103. The data stored in the system memory unit 300 comprises a unique identifier (UID) 303 of the NFC device 103 and a device configuration 304. The device configuration data is used to configure the operation of the NFC device 103. The user configuration memory unit 301, which is directly accessible to the user, comprises a V-field first byte address 305, a logged first byte address 306 and a logged counter 307. The V-field first byte address 305 stores a user-defined address representing a first byte address of a V-field 406, which indicates the location of the V-field 406. The V-field 406 is one of the three fields of a TLV structure, according to the NFC Data Exchange Format (NDEF) technical specification. TLV is an abbreviation for three different fields: T for tag field, L for length field and V for value field. A TLV block consists of one or more bytes, depending on which of these three fields is present. The last TLV block, is a terminator TLV, consists of a single byte: 0xFE. The terminator TLV 403 presents the end of the NDEF message 402. The data next to the terminator TLV 403 consists of unnecessary data that should not be utilized in communication. The terminator TLV 403 is obtained by calculating the Length field 405 according to FIG. 5A and 5B that will further describe. The terminator TLV 403 and the Length field 405 indicate the last of the information utilized in the communication, effectively pointing that the NFC enabled device 100 can retrieve only the necessary data while leaving unnecessary data in the memory unit 205 from the communication process. The terminator TLV 403 block is mandatory in the NDEF format.

The V-field 406 is stored in the user data memory unit 302. The user data memory unit 302 usually stores general data from the user such as a capability container (CC) 401 and/or an NDEF message 402. The CC 401 indicates actual space utilized for storing data in the memory unit 205. As defined in NFC data exchange format technical specification, the NDEF message 402 comprises a Type field 404, a Length field 405, and a Value field (V-field) 406. The Type field 404 is a data byte that indicates the type of the V-field 406 in the NDEF message 402. The Length field 405 indicates the size of the V-field 406 in the NDEF message 402. According to the present invention, the Length field 405 is variable depending on the size of the V-field 406. The V-field 406 includes data stored in the user data memory unit 302, which comprise URIs 407 and the data 408. The data 408 is obtained from the peripheral unit 206, which is the form of a first data format. The terminator TLV (0xFE) 403 is utilized to terminate the NDEF message 402. The end of transmission of the NDEF message 402 to the NFC enabled device 100 is signified by the terminator TLV 403.

The logged first byte address 306 stores the user-defined address representing the first byte address location of the data 408 in the user data memory unit 302. This value is a starting point of the user data memory unit 302, where the processing unit 204 stores data obtained from the peripheral unit 206. The logged counter 307 is a section of the user configuration memory unit 301, used for storing a counter value that indicates the number of times data has been recorded to the memory unit 205.

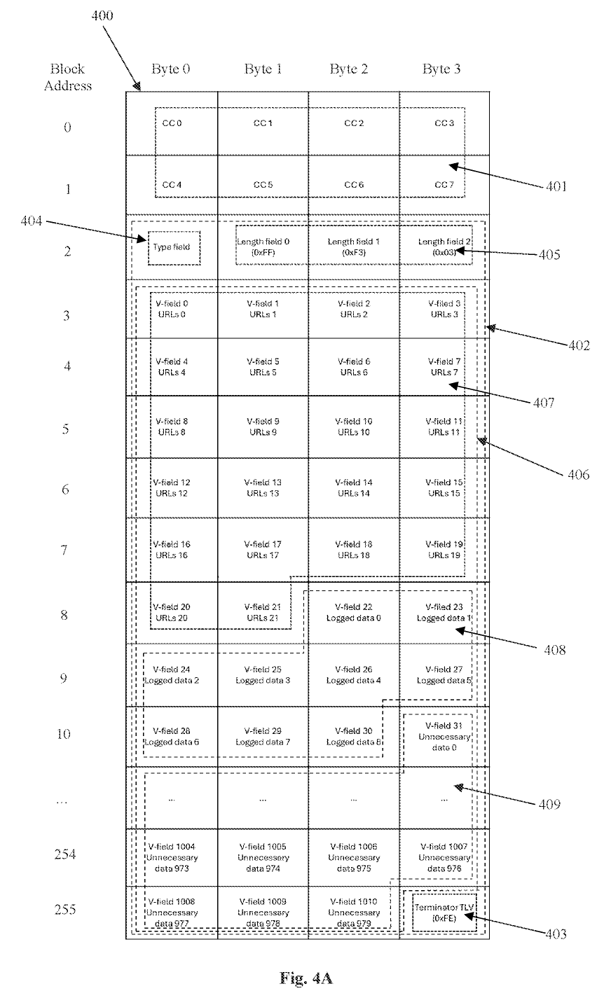

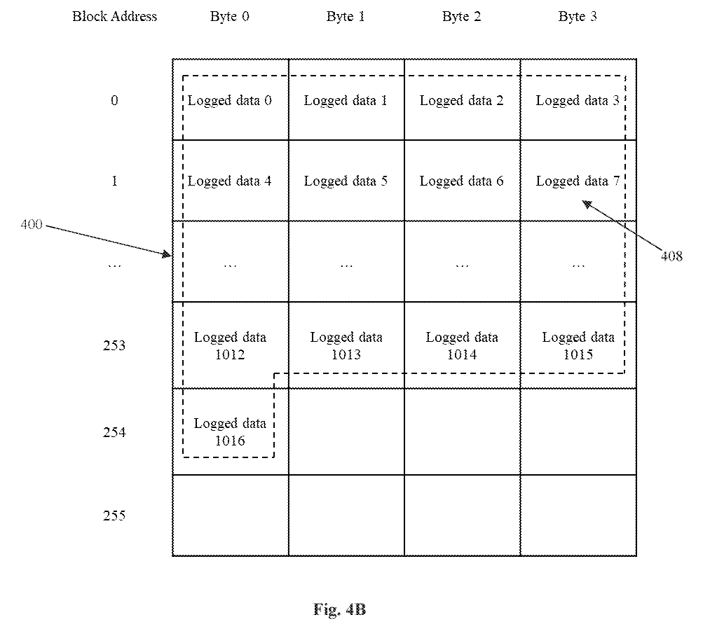

According to prior arts, the storage memory of the NFC device is illustrated as shown in FIG. 4A. The NFC enabled device 100 reads all data stored in the storage memory 400, which comprises a capability container (CC) 401, an NFC data exchange format (NDEF) message 402 and a terminator TLV (0xFE) 403. The NDEF message 402 comprises Type field 404, Length field 405, and V-field 406. In prior arts, the Length field 405 is fixed by the maximum capability of the V-field 406, which is stored in the storage memory 400 the NFC device 103. The V-field 406 comprises URIs 407, the data 408 and other unnecessary data. The Length field 405 is typically equal to a full storage capacity of the V-field 406. For example, if the full storage capacity of the V-field 406 is 989 bytes, it contains only 9 bytes of the data 408 and the remaining 980 bytes is empty or unnecessary data, which is referred to as the factory default data and is typically 0x00. When the NFC enabled device 100 sends a command to the NFC device 103 requesting for NDEF messages 402, the NFC device 103 responds to the command by sending all NDEF messages 402, which comprises the Type field 404, the Length field 405 and all 989 bytes of data in the V-field 406, including the data 408, the unnecessary data and the factory default data. The factory default data is a predefined values set by the NFC tag manufacturer. Thus, the communication between the NFC enabled device 100 and the NFC device 103 take an unnecessarily long time to retrieve all necessary data that the NFC enabled device request since all data, includes the data 408, the unnecessary data and the factory default data.

The abovementioned issue of unnecessary long communication time between the NFC enabled device 100 and the NFC device 103 is overcome by using an application software 101 installed in the NFC enabled device 100. According to prior arts, the storage memory 400 of the NFC device 103 used with the NFC enabled device 100 and the application software 101 is illustrated as shown in FIG. 4B. The NFC enabled devices 100 uses the application software 101 to identify the size of the data 408 so that it only retrieves the data 408 stored in the storage memory 400, therefore avoiding the issue of unnecessary long communication time. The data 408 is formatted in various ways, depending on the NFC device 103 and the application software 101. When the NFC enabled device 100 receives the data 408, the application software 101 converts the data 408 to display to the user. Unlike the present invention that will be further described in FIG. 5A and 5B, the application software is not required to resolve such unnecessary long communication time.

FIGS. 5A and 5B illustrate the user data memory unit of the NFC device, according to an exemplary embodiment of the present invention. The user data memory unit 302 comprises the capability container (CC) 401, the NFC data exchange format (NDEF) message 402, the data 408, and the terminator TLV (0xFE) 403. The CC 401 includes a data structure outlining important information about the capabilities and configurations of the NFC device 103. The CC 401 includes essential information of the NFC device 103 such as its memory unit size, mapping version, access permissions for reading and writing data, and other parameters specified by the NFC Forum specification. The CC 401 is configured to provide necessary information, such as functionalities, of the NFC device 103 to the NFC enabled device 100, thus allowing the NFC enabled device 100 to understand and interact with the NFC device 103 effectively and ensuring proper data access and utilization. The NDEF message 402 includes data format and pattern. As defined in the NFC data exchange format technical specification, the NDEF message 402 comprises the Type field 404, the Length field 405, and the V-field 406, as shown in FIG. 5A.

The Type field 404 is a data byte that indicates the type of the V-field 406 in the NDEF message 402. The Length field 405 indicates the size of the V-field 406 in the NDEF message 402. According to the present invention, the Length field 405 is variable depending on the size of the V-field 406. The V-field 406 includes data stored in the user data memory unit 302, which comprise URIs 407 and the data 408. The data 408 is obtained from the peripheral unit 206. The data 408 is in the form of a first data format. The terminator TLV (0xFE) 403 is a dedicated TLV structure used to terminate the NDEF message 402. The terminator TLV 403 denotes the end of the NDEF message 402 that transmitted to the NFC enabled device 100 in each communication between the NFC enabled device 100 and the NFC device 103.

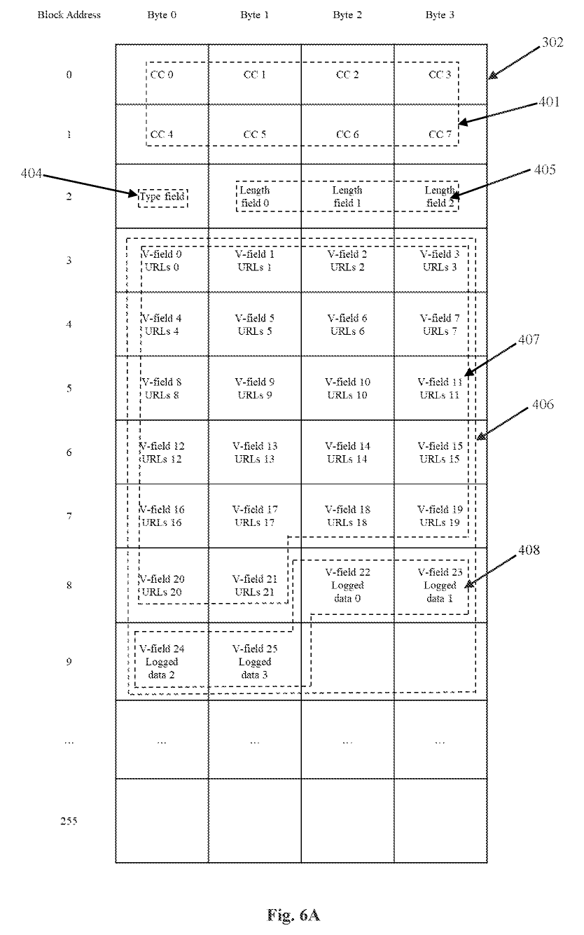

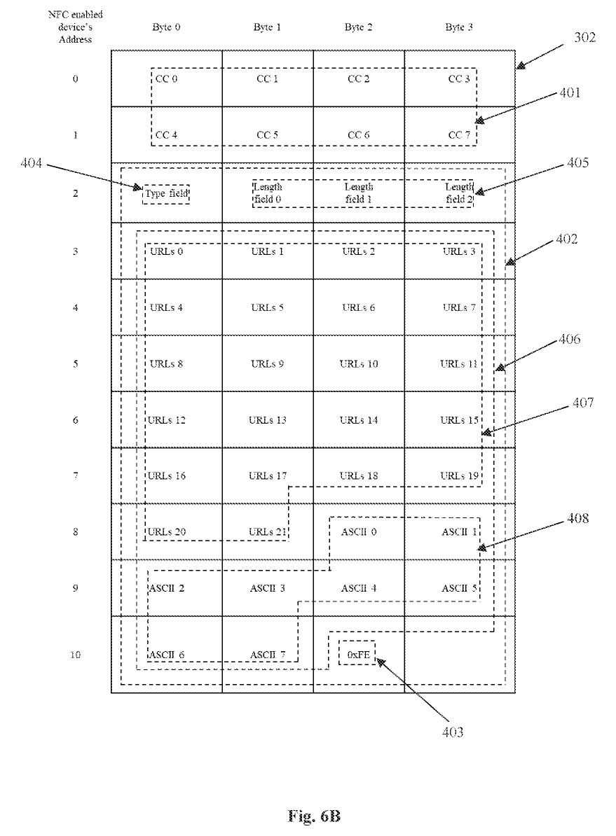

According to an embodiment of the present invention, communication between the NFC enabled device 100 and the NFC device 103 comprises the steps as follows. The NFC enabled device 100 sends a command to the NFC device 103 to request for an information such as an NDEF message 402. Upon receiving the command from the NFC enabled device 100, the processing unit 204 of the NFC device 103 calculates the length of the requested NDEF message 402 by calculating the difference between an address of V-field and an address of data 408 to obtain the length of URIs 407 and determining the size of the data 408 in form of the second data format. To calculating of such difference, this present invention prefers to choose the first address of the V-field (V-field first byte address) 305 and the first address of data (logged first bye address) 306 to be an address of the V-field and the data, accordingly. Typically, the first data format is the Hexadecimal (HEX) data format which uses less storage area of the user data memory unit 302. The second data format is the ASCII data format required for data transmission from the NFC device 103 to the NFC enabled device 100, as specified by the NFC Data Exchange Format (NDEF) technical specification. However, storing the data 408 in the ASCII format requires a relatively larger storage area of the user data memory unit 302. For example, if the data 408 stored in the first data format of Hexadecimal format is 0x47 (1 byte), the same data 408 stored in the second format of ASCII must be expanded to 0x34 and 0x37 (2 bytes). To save the storage area in the user data memory unit 302, the processing unit 204 of the present invention stores the data 408 in the first data format, and it determines only the expanded size of the first format, resulting in the size of the second format. The processing unit 204 determines the length of the NDEF message 402 by adding the length of the URIs 407 with the size of the data 408 in the second data format, and the resulting length of the NDEF message 402 which is stored in the user data memory unit 302. The NFC device 103 converts the data 408 in form of the first data format into the second data format. The data 408 in form of the second data format is included with the NDEF message 402. Next, the processing unit 204 remaps each of addresses requested from the NFC enabled device 100 with each of addresses from the user data memory unit 302. The addresses requested from the NFC enabled device 100 depend on size of the data in form of the first data format and the addresses from the user data memory unit 302 depends on size of the data in form of the second data format. Then the NFC device 103 waits to transmit response, according to the NFC Forum technical specification. For instance, if the address requested from the NFC enabled device 100 is the address 8 according to FIG. 5B, which includes URIs20, URIs21, ASCII0 and ASCII1, the ASCII0 and ASCII1 are converted from data 0 at the block address 8 byte 2 of the user data memory unit 302 according to FIG. 5A. If the address requested from the NFC enabled device 100 is the address 9 according to FIG. 5B, which includes ASCII2, ASCII3, ASCII4 and ASCII5, the ASCII2 and ASCII3 are converted from data 1 at the block address 8 byte 3 of the user data memory unit 302, the ASCII4 and ASCII5 are converted from data 2 at the block address 9 byte 0 of the user data memory unit 302 according to FIG. 5A. Then, the NFC device 103 transmits the NDEF message 402 to the NFC enabled device 100, according to FIG. 5B. For example, if the amount of the data 408 in the first format is 4 bytes, the data 408 is converted to 8 bytes of the second format, as shown in FIGS. 6A and 6B. Using the abovementioned method, the present invention does not require the application software 101 and can reduce the communication time between the NFC device 103 and the NFC enabled device 100 because the processing unit 204 provides the length correlated the V-field 406 without any unnecessary data to the NFC enabled device 100.

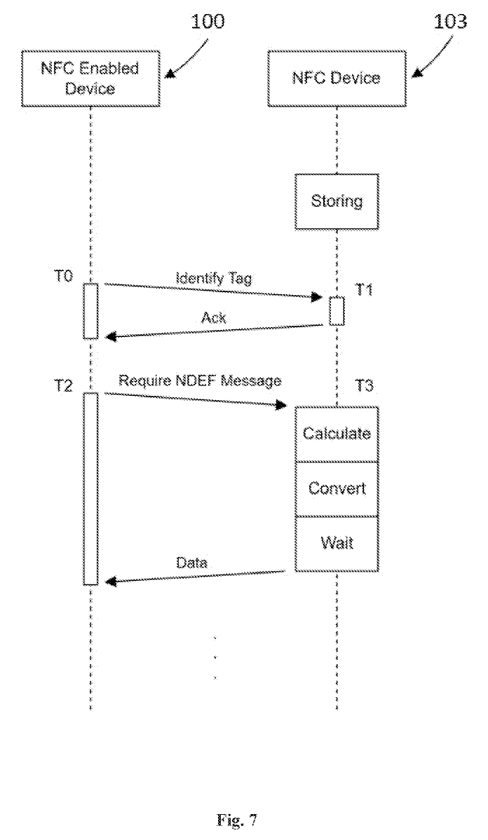

FIG. 7. shows a sequence diagram of the method of providing NDEF messages, according to the present invention. The NFC device 103 stores the data 408 in the form of the first format in the user data memory unit 302. During T0 to T1, the NFC device 103 is identified by the NFC enabled device 100, according to the NFC Forum technical specification. At T2, the NFC enabled device 100 sends a command to request an NDEF message 402 from the NFC device 103. At T3, from the NFC device 103 receives the command from the NFC enabled device 100 and begins to provide the requested NDEF message 402. The NFC device 103 provides the requested NDEF message 402 by calculating the length of the NDEF message 402, converting the data 408 from the first data format to the second data format, remapping addresses from the memory unit 205 of the NFC device 103 to requested addresses by the NFC enabled device, and waiting to transmit response to the NFC enabled device 100.

What is claimed is:

1. A method for providing NFC data exchange format messages, comprising:
calculating a length of an NDEF message by an NFC device, further comprising:
calculating a length of a URI using an address of a V-field and an address of data stored in a memory unit of the NFC device, wherein the data is stored in a first data format;
determining a size of the data in form of a second data format;
adding the length of the URI with the size of the data in form of the second data format to obtain the length of the NDEF message; and
storing the length of the NDEF message in the memory unit of the NFC device;
converting the data from the first data format to the second data format; and
remapping addresses from the memory unit of the NFC device to requested addresses by an NFC enabled device.

2. The method of claim 1, wherein the addresses from the memory unit of the NFC device are addresses that are dependent on the size of the data in form of the first data format.

3. The method of claim 1, wherein the requested addresses by the NFC enabled device are addresses that are dependent on the size of the data in form of the second data format.

4. The method of claim 1, wherein the size of the data in form of the second data format is derived from the size of the data in form of the first data format.

5. The method of claim 1, wherein the first data format is Hexadecimal (HEX) and the second data format is ASCII.

6. The method of claim 1, wherein the address of the V-field and the address of the data stored in the memory unit are a first address of the V-field and a first address of the data.

7. The method of claim 1, wherein calculating the length of the URI is obtained by calculating the difference between the first address of the V-field and the first address of the data.

8. The method of claim 1, wherein the second data format is the data format of the transmitted data to the NFC enabled device.

9. An NFC device, comprising:
an NFC’s device antenna attached to the NFC device, wherein the NFC’s device antenna is configured to receive an electromagnetic wave transmitted by an NFC enabled device, and converts the electromagnetic wave to an electrical signal;
an analog interface coupled to the NFC’s device antenna, wherein the analog interface is configured to receive an NDEF message’s request from the NFC enabled device;
a memory unit configured to store data in form of a first data format; and
a processing unit configured to calculating a length of an NDEF message, further comprising:
calculating a length of a URI using an address of a V-field and an address of the data stored in the memory unit;
determining a size of the data in form of a second data format;
adding the length of the URI with the size of the data in form of the second data format to obtain the length of the NDEF message; and
storing the length of the NDEF message in the memory unit;
converting the data stored in the memory unit from the first data format to the second data format; and
remapping addresses from the memory unit of the NFC device to requested addresses by the NFC enabled device.

10. The NFC device of claim 9, further comprising a peripheral unit configured to collect the data and send the data to the processing unit.

11. The NFC device of claim 9, wherein the memory unit further comprising:
system memory unit configured to store indicative data of the NFC device;
a user configuration memory unit configured to store a first address of V-field, a first address of the data and a counter value; and
a user data memory unit configured to store user’s data.

12. A communication system, comprising:
an NFC device, wherein the NFC device comprises:
an NFC’s device antenna attached to the NFC device, wherein the NFC’s device antenna is configured to receive an electromagnetic wave transmitted by an NFC enabled device, and converts the electromagnetic wave to an electrical signal;
an analog interface coupled to the NFC’s device antenna, wherein the analog interface is configured to receive an NDEF message’s request from the NFC enabled device;
a memory unit configured to store data in form of a first data format; and
a processing unit configured to calculating a length of an
NDEF message, further comprising:
calculating a length of a URI using an address of a V-field and an address of the
data stored in the memory unit;
determining a size of the data in form of a second data format;
adding the length of the URI with the size of the data in form of the second data format to obtain the length of the NDEF message; and
storing the length of the NDEF message in the memory unit;
converting the data stored in the memory unit from the first data format to the second data format; and
remapping addresses from the memory unit of the NFC device to requested addresses by the NFC enabled device; and
an NFC enabled device, wherein the NFC enabled device is configured to request a service from the NFC device and to receive an NDEF message in response to the request from the NFC device.

13. The communication system of claim 12, wherein the NFC device is configured according to the NFC Forum Technical Specification.

14. The communication system of claim 12, wherein the NFC enabled device is configured as an NFC enabled device by the NFC Forum Technical Specification or an RFID reader.
